(19) United States
(12) Patent Application Publication
(10) Pub. No.: US 2026/0011332 A1
(43) Pub. Date: Jan. 8, 2026

(54) METHOD AND SYSTEM FOR AUTOMATED SPEAKER ENROLLMENT

(71) Applicant: REALTEK SEMICONDUCTOR CORP., HSINCHU (TW)

(72) Inventors: MING-TANG LEE, HSINCHU (TW); Chung-Shih Chu, HSINCHU (TW)

(21) Appl. No.: 19/257,687

(22) Filed: Jul. 2, 2025

(30) Foreign Application Priority Data
Jul. 3, 2024 (TW) 113124801

(51) Int. Cl. G10L 17/04; G06T 7/521; G06T 7/55; G06T 7/70; G06V 40/16; G10L 17/02; G10L 17/18; G10L 25/78; G10L 25/90

(52) U.S. Cl. CPC G10L 17/04; G06T 7/521; G06T 7/55; G06T 7/70; G06V 40/172; G10L 17/02; G10L 17/18; G10L 25/78; G10L 25/90; G06T 2207/30201

(57) ABSTRACT

A method and a system for automated speaker enrollment are provided. In the method, a camera is used to capture image data so that a facial position of a person can be recognized, a microphone array is used to generate speech data, and a sound localization technology is used to estimate a sound source direction. A target speaker can be determined by matching the facial position and the direction toward the sound source, and more particularly whether the target speaker is within a valid geometric range. After that, the speech produced by the target speaker along a target speaker direction is recorded, and the speech can be enhanced for generating speaker features with respect to the target speaker for enrolling to a specific system.

### CROSS-REFERENCE TO RELATED PATENT APPLICATION

This application claims the benefit of priority to Taiwan Patent Application No. 113124801, filed on Jul. 3, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a technology of performing enrollment with audio features, and more particularly to a method and a system for automated speaker enrollment using images and audio information.

### BACKGROUND OF THE DISCLOSURE

Personalized speech enhancement (PSE) technology is used to extract speaker embedding vectors from speech data for obtaining speaker features. The speaker features are referred to for enhancing speech of a specific speaker (e.g., a person). The speaker features are often obtained in advance by a speaker enrollment process. In the speaker enrollment process, after speech data of the specific speaker is collected, a voiceprint recognition model is applied for calculating the speaker features. However, the step of applying the voiceprint recognition model is an additional setting step that the speaker may need to perform, and also makes a personalized speech enhancement system more complicated.

Thus, a conventional technology such as an automated enrollment process has been developed for reducing complexity of the personalized speech enhancement.

The automated enrollment process requires a method for choosing a target speaker, such as relying on a lip motion in a video to choose one of the speakers. Technologies of facial recognition and lip motion are used to determine a recording timing for the target speaker to perform enrollment. In practice, it is possible that determination of lip motion is affected if the face of the speaker is obscured or the speaker turns their head away. Alternatively, the recognition will fail if the speaker wears a mask. Therefore, if the lip motion and audio are used in speech enhancement, a situation where the lips are obscured should be taken into consideration. The speaker features can assist in dealing with this situation, but valid information of lip movement is still necessary.

### SUMMARY OF THE DISCLOSURE

For effectively applying a lip motion to choose a speaker and performing speech enhancement, provided in the present disclosure is a method and a system for automated speaker enrollment that can effectively acquire valid lip motion information for performing automatic enrollment. The technical concept of the method is to use images and speech to choose a target speaker by limiting a geometric area and record speech of the target speaker, so as to generate speaker features for enrolling to a specific system.

In one aspect, the automated speaker enrollment system essentially includes a camera and a microphone array. The microphone array includes at least two microphones disposed at different positions. A computer system performs the method for automated speaker enrollment. In the method, the camera is used to capture images so as to generate image data. Facial positions of at least one person can be recognized. The microphone array receives audio and generates speech data. Sound localization is performed for estimating a sound source direction. After that, the facial position of the at least one person and the sound source direction are referred to for matching the target speaker. Speech data to be received along a target speaker direction is recorded. The speech data can be used to form the speaker features of the target speaker to be enrolled in a specific system.

Further, when the microphone array receives the audio, it is detected whether or not any speaker is speaking according to pitch or volume of the received speech data. The sound localization can be performed based on the speech data when it is confirmed that the speaker is speaking within a valid geometric range. The image captured by the camera can be used to determine whether or not at least one person is present. Facial recognition is performed when the at least one person being present within the valid geometric range is confirmed.

Further, the facial position of the at least one person includes a distance being estimated based on a focus distance of the camera from the face of the at least one person, and the image captured by the camera can be used to determine a direction of the face of the at least one person. The facial position of the at least one person within the valid geometric range and the sound source direction within the valid geometric range are referred to for matching the target speaker and confirming the target speaker direction.

Still further, after the speech data of the target speaker is recorded, the speech data is processed by quality checking, beamforming and noise reduction, so as to generate the enhanced speech. The speech data of the target speaker is converted to a low-dimensional array for forming a speaker embedding vector that acts as speaker features for the automated speaker enrollment system.

In one aspect of the present disclosure, the method for automated speaker enrollment can be operated in an operating system, the speaker features of the target speaker can be used for automatically enrolling to the operating system. The target speaker can log on the operating system by their speech.

### BRIEF DESCRIPTION OF THE DRAWINGS

The described embodiments may be better understood by reference to the following description and the accompanying drawings, in which:

FIG. 1 is a schematic diagram illustrating an application scenario of an automated speaker enrollment system;

FIG. 2 is a schematic diagram illustrating components of the automated speaker enrollment system according to one embodiment of the present disclosure;

FIG. 3 is a schematic diagram illustrating a target speaker detection unit of the automated speaker enrollment system according to one embodiment of the present disclosure;

FIG. 4 is another schematic diagram illustrating the automated speaker enrollment system according to another embodiment of the present disclosure;

FIG. 5 is a schematic diagram illustrating a speech enhancement unit of the automated speaker enrollment system according to one embodiment of the present disclosure; and

FIG. 6 is a flowchart illustrating a method for automated speaker enrollment according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a method and a system for automated speaker enrollment, and an automated speaker enrollment system. The objectives of the method are, in addition to reducing complexity of personalized speech enhancement, also to provide technical solutions of choosing a target speaker by limiting a geometric area and recording speech of the target speaker. In an exemplary example, an image recognition technology is incorporated to acquire a facial angle and a distance of the face of the target speaker. Further, a horizontal angle of the face of the speaker can also be estimated through a microphone array. Accordingly, the target speaker can be chosen and speech enhancement can be performed when recording the speech of the target speaker for automatically enrolling to a specific system. Thus, compared with the conventional technology that chooses the speaker based on a lip motion, the method for automated speaker enrollment of the present disclosure can determine the target speaker more accurately even if the speaker is wearing a mask.

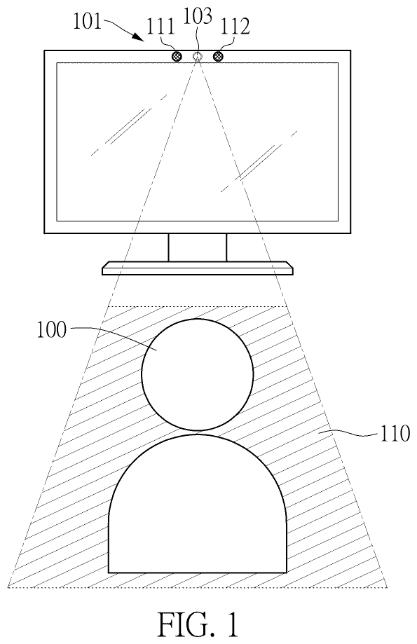

Reference is made to FIG. 1, which is a schematic diagram illustrating a scenario where the automated speaker enrollment system is applied. According to one embodiment of the automated speaker enrollment system, the automated speaker enrollment system uses a computer system that includes a processor, a memory and a storage device to embody software functions. An operating system is operated in the computer system, and the operating system can exemplarily be an embedding system for a specific device. The automated speaker enrollment system also includes some main hardware components such as a camera and a microphone array that can electrically connect with the computer system via an interface. The method for automated speaker enrollment operated in the automated speaker enrollment system allows a user to enroll to the operating system by a speech. In an exemplary example, after the user successfully enrolls his speech to an operating system operated in a specific device, the user can log on the operating system by his speech.

FIG. 1 schematically shows a speaker 100 who is within a valid geometric range 110 set by the automated speaker enrollment system. One of the main components of the automated speaker enrollment system is such as a microphone array 101 disposed on a display. The microphone array 101 includes at least two microphones respectively disposed at different positions. As shown in the diagram, a first microphone 111 and a second microphone 112 that are at a distance apart and a camera 103 are included.

The automated speaker enrollment system uses the processor of the computer system to perform the software functions that are configured to perform the method for automated speaker enrollment. According to the exemplary example in the diagram, the software and hardware components of the operating system are in operation for driving the camera 103 to capture images within the valid geometric range 110. The images include an image of a head of the speaker 100 within the valid geometric range 110. The microphone array 101 is simultaneously driven to receive speech data when the speaker 100 speaks through the microphones at different positions.

After the automated speaker enrollment system obtains the image data and the speech data, an image recognition technology is used to identify a facial image of at least one person (e.g., the speaker 100) and determine a facial position. Even if multiple persons are within the valid geometric range 110, the positions of each of the persons can be well identified. In the meantime, the facial position and a distance of the speaker 100 can be estimated and recognized as a sound source based on the speech data retrieved by the microphone array 101. Thus, the automated speaker enrollment system checks whether or not the facial position estimated from the image data is matched with the position of the sound source estimated from the speech data through image processing. When the facial position and the position of the sound source are confirmed to be matched, the automated speaker enrollment system can identify a target speaker and starts to record speech of the target speaker after speech quality is ensured.

According to certain embodiments of the present disclosure, the camera 103 in the automated speaker enrollment system is configured at a position to be capable of capturing the face of the speaker 100. Parameters of the camera 103 such as a focal length form the valid geometric range 110. For example, the area represented by oblique section lines shown in FIG. 1 acts as the valid geometric range 110, where a direction and a distance of the speaker 100 with respect to the camera 103 can be recognized.

Further, in a process of estimating a position of at least one person (e.g., the speaker 100) in front of the camera 103, a distance of the speaker 100 (i.e., a facial distance) from the camera 103 can be obtained according to, but not limited to, the focus distance. It should be noted that the way to obtain the distance of the speaker 100 is not limited to the parameters of the camera 103. For example, an infrared light emitted by an infrared emitter can be used to estimate the distance of the speaker 100 when a reflective infrared light is measured by an infrared camera, a time-of-flight (ToF) method can be performed in the automated speaker enrollment system for estimating the distance between the speaker 100 and the camera 103 according to a time difference between an emitting signal and a reflective signal light, and the direction (i.e., the facial direction) and the position of the speaker 100 relative to the camera 103 can be determined based on the facial features of the speaker 100. Further, a structured light emitted by an emitter can be used to estimate the position of the speaker 100 according to a specific type of the structured light. Still further, two cameras are used to capture two respective images of the speaker 100 at the same time, and a triangulation method is performed on the two images for calculating the distance between the speaker 100 and the camera 103.

In one of embodiments of the present disclosure, referring to FIG. 1, the microphone array 101 includes at least two microphones disposed at different positions. For example, a first microphone 111 and a second microphone 112 are respectively used to retrieve speech data from the speaker 100. The direction of the speaker 100 can be obtained by analyzing the speech data and matched with the image of the speaker 100 analyzed from image data. When matching the direction of the speaker 100 and the image of the speaker 100, the speech to be received outside the valid geometric range 110 can be excluded, and the event that the speaker 100 within the valid geometric range 110 does not speak can also be excluded.

In one further embodiment of the present disclosure, the microphone array 101 includes two or more microphones (such as the first microphone 111 and the second microphone 112 shown in the diagram) that allow the automated speaker enrollment system to calculate a time difference between the times to receive the same speech by two of the microphones based on the speech data. The time difference is referred to for estimating a direction toward the sound source. Taking two microphones as an example, a relationship between the time difference (τ) and an incident angle (θ) is “τ=d (sin θ/c)”, in which “d” denotes a distance between the two microphones. The incident angle is an included angle between an incident direction and a line connecting the two microphones. When the quantity of the microphones is more than two and the microphones are not arranged on the same line, the incident direction can be divided into a horizontal angle and an elevation angle and can be used to estimate the sound source direction, i.e., the position of the speaker 100.

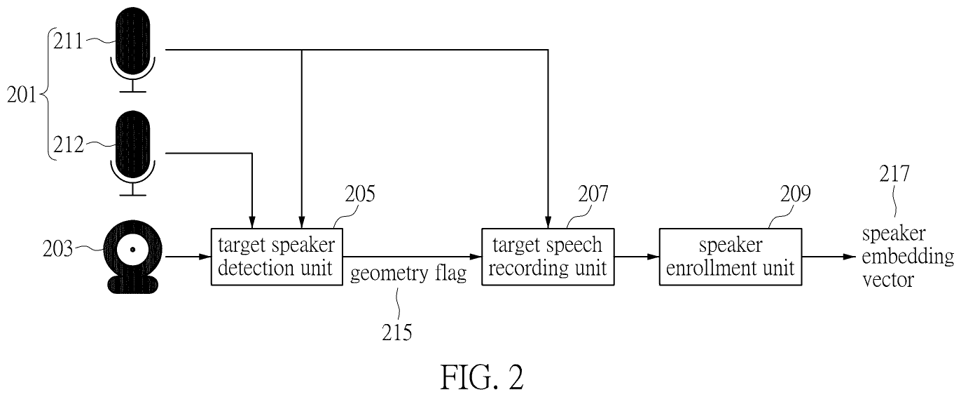

FIG. 2 is a schematic diagram illustrating the automated speaker enrollment system according to one embodiment of the present disclosure. The automated speaker enrollment system is implemented by a computer system, and the software functions operated in the automated speaker enrollment system are performed by a processor. The automated speaker enrollment system includes specific hardware such as a microphone array 201 and a camera 203.

According to certain embodiments of the present disclosure, the automated speaker enrollment system uses software means to embody some main functional components such as a target speaker detection unit 205, a target speech recording unit 207 and a speaker enrollment unit 209. These functional components combined with the microphone array 201 including a first microphone 211 and a second microphone 212 and a camera 203 collaboratively operate the method for automated speaker enrollment.

In the automated speaker enrollment system, the target speaker detection unit 205 relies on the speech data generated by the microphone array 201 and/or the image data generated by the camera 203 to detect whether or not any speaker appears within the valid geometric range. A geometry flag 215 is generated according to a detection result and provided to the speech recording unit 207.

According to one of the embodiments of the present disclosure, by the target speaker detection unit 205, when the microphone array 201 receives audio, an audio-processing technology is used to process the audio so as to obtain pitch or volume of the audio. The pitch or the volume of the audio is referred to for detecting whether or not any speaker is speaking. When it is confirmed that any speaker is speaking within the valid geometric range 110 shown in FIG. 1, the speech data is referred to for sound localization. In addition, the image captured by the camera 203 can be used to determine whether or not at least one person is present after performing image recognition on the image. Facial recognition is performed when the at least one person being present within the valid geometric range 110 is confirmed.

Further, when any speaker within the valid geometric range is detected, the first microphone 211 and the second microphone 212 of the microphone array 201 disposed at a distance apart from each other are used to receive the speech generated by the speaker within the valid geometric range. A sound localization technology is used to analyze a time difference between the speech data received at different positions so as to estimate the position and the distance of the speaker within the valid geometric range. The purpose of detecting the speaker is achieved. On the other hand, the camera 203 can be used to acquire the images within the valid geometric range and detect whether any person is present within the range by an image recognition technology. Based on the above-mentioned information, the target speaker detection unit 205 generates the geometric flag 215 for labeling the speaker or any other person to be detected within the valid geometric range.

For example, the geometry flag 215 can be represented by a numeral “O” for indicating that there is no the target speaker to be detected within the valid geometric range, and another numeral “1” for indicating the target speaker to be detected within the valid geometric range. Therefore, the target speech recording unit 207 relies on the geometry flag 215 to determine whether or not to start recording the speech of the target speaker. When it is confirmed that the target speaker is within the valid geometric range according to the geometry flag 215, the target speech recording unit 207 starts recording the speech of the target speaker and generates speech data. The speech data is provided for the speaker enrollment unit 209 to perform enrollment so as to generate a speaker embedding vector 217.

According to one embodiment of the present disclosure, the speaker enrollment unit 209 performs a machine-learning algorithm or a deep learning method that extracts the speaker embedding vector 217 from the speech data. The speaker embedding vector 217 is used as the speaker features of the speaker. The speaker embedding vector 217 can be outputted to the computer system with a speech login function.

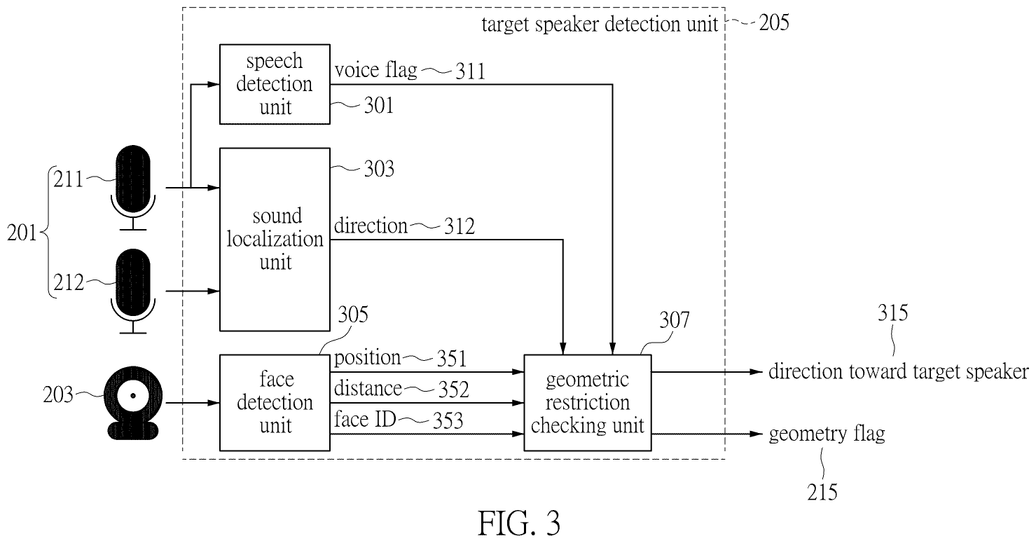

Reference is made to FIG. 3, which is a schematic diagram illustrating the target speaker detection unit of the automated speaker enrollment system according to one embodiment of the present disclosure.

The functional components of the target speaker detection unit 205 include a speech detection unit 301, a sound localization unit 303, a face detection unit 305 and a geometric restriction checking unit 307 that are collaboratively implemented by software and hardware with a certain computing power.

According to one embodiment of the present disclosure, the speech detection unit 301 is used to detect whether or not any audio signal is received by the system, so as to detect whether any speaker is speaking. One of the schemes to detect a speaker that is speaking is to acquire the speech signals generated by any of the microphones (e.g., the first microphone 211) of the microphone array 201 and extract sound frequency (i.e., the pitch) or sound amplitude (i.e., the intensity) from the speech signals. After the noise is reduced, it can be determined whether the speaker is nearby. The speech detection 301 then establishes a voice flag 311 according to a detection result. The voice flag 311 can be “0” to indicate that no sound is made by the speaker to be detected, and can be “1” to indicate that the speech made by the speaker is detected. The speech data are then provided to the geometric restriction checking unit 307.

On the other hand, the sound localization unit 303 can obtain the speech data received by the microphones (i.e. the first microphone 211 and the second microphone 212) of the microphone array 201. According to the above embodiments, the sound localization unit 303 can rely on a time difference between the speech made by the speaker and the time that the speech reaches the multiple microphones to estimate a sound source direction. For example, a sound localization technology such as steered-response power with phase transform (SRP-PHAT) is used to estimate multiple directions toward multiple sound sources based on the environmental sounds. The information of the directions (312) toward multiple sound sources is outputted to the geometric restriction checking unit 307.

The automated speaker enrollment system drives the camera 203 to operate, and the face detection unit 305 obtains image data from the camera 203 for identifying facial position and size of the face of the speaker according to the facial image features by an image recognition technology. The above-mentioned information can be converted to the direction and distance of the face of the speaker relative to the camera 203 by referring to the parameters (e.g., focal length) of the camera 203. Multiple sets of directions and distances may be obtained if multiple faces are detected from the image data. The related parameters such as a position 351, a distance 352 and recognized face IDs 353 are provided to the geometric restriction checking unit 307. It should be noted that the human face detection technology used in the face detection unit 305 can adopt a model that is trained by learning the facial features with a neural network deep-learning method. This model is used to detect a human face from an image. If multiple faces in the image are recognized, these faces can be numbered sequentially. The face ID 353 is provided for the automated speaker enrollment system to identify the human face.

In the method for automated speaker enrollment, the geometric restriction checking unit 307 receives information from the above-described components, such as the voice flag 311 provided by the speech detection unit 301, the direction 312 toward the sound source provided by the sound localization unit 303, and the position, the distance 352 and the face ID 353 provided by the face detection unit 305, and the geometric restriction checking unit 307 relies on the information to conduct filtering so as to output the geometry flag 215 that indicates whether the target speaker is detected within the valid geometric range by the flag of “0” or “1.”

For example, when the voice flag 311 provided by the speech detection unit 301 is “1”, it indicates that there is a speaker nearby. Next, one or more valid faces can be filtered out by distances (352) of the faces from the camera 203. The one or more valid faces are then matched with the position 351 provided by the face detection unit 305 and the direction 312 toward the sound source to be estimated by the sound localization unit 303, so that whether the target speaker is within the valid geometric range can be determined. Accordingly, the geometric restriction checking unit 307 outputs the geometry flag 215, and a direction toward the target speaker (315) can be provided when the geometry flag 215 is “1.” Otherwise, when the geometric restriction checking unit 307 fails to match the target speaker based on the above-mentioned information, it indicates that no speech from a target speaker is detected even if there is someone within the valid geometric range, and accordingly the geometry flag “0” is outputted, or no one is detected within the valid geometric range and geometry flag “0” is also outputted.

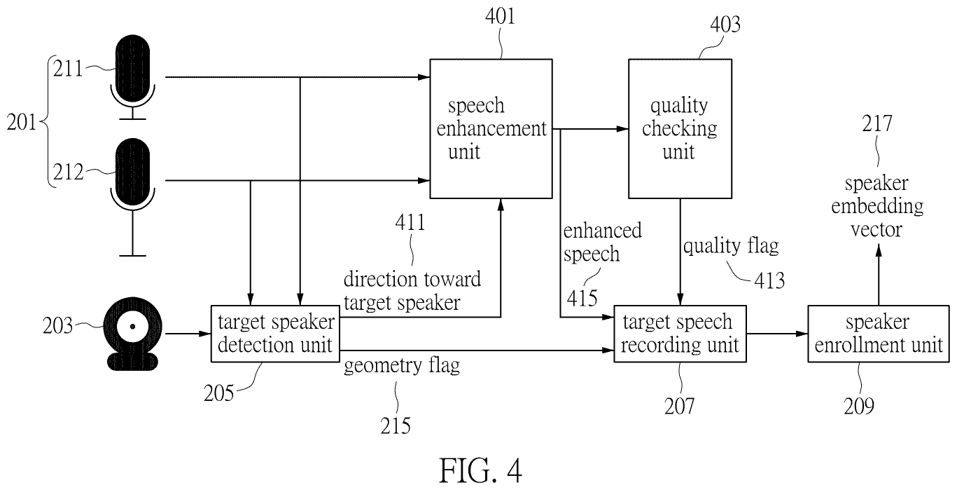

FIG. 4 is another schematic diagram illustrating the automated speaker enrollment system according to one embodiment of the present disclosure.

In addition to the above-described target speaker detection unit 205, the target speech recording unit 207 and the speaker enrollment unit 209, the automated speaker enrollment system further includes a speech enhancement unit 401 used to perform speech enhancement and a quality checking unit 403 used to ensure quality of enrollment speech.

The automated speaker enrollment system uses the target speaker detection unit 205 to detect whether any speaker is within the valid geometric range according to the speech data generated by the microphone array 201 including the first microphone 211 and the second microphone 212, and the image data obtained from the camera 203. A corresponding geometry flag 215 and a target speaker direction (411) are outputted. The geometry flag 215 “1” indicates that the target speaker is detected within the valid geometric range, and the geometric flag 215 is provided for the target speech recording unit 207 to record speech of the target speaker. On the other hand, the target speaker direction (411) is outputted to the speech enhancement unit 401.

In the present embodiment, the speech enhancement unit 401 obtains the speech data from the multiple microphones of the microphone array 201, such as the speech data provided by the first microphone 211 and the second microphone 212, and performs speech enhancement according to the target speaker direction (411). A speech enhancer can be selectively used to enhance speech quality for outputting the speech data with sufficient quality and suitable for enrollment. An enhanced speech 415 is then outputted to the quality checking unit 403 and the target speech recording unit 207.

The enhanced speech 415 can also be processed by the quality checking unit 403 for quality checking, and the quality of the enhanced speech 415 is notified to the target speech recording unit 207 by the quality flag 413 that can also indicate that whether the speech data is sufficiently representative of the target speaker for enrollment. For example, quality flag “1” indicates good speech quality, and quality flag “0” indicates bad speech quality. According to one embodiment of the present disclosure, indicators for assessing the speech quality includes a subjective indicator, for example, a MOS-Net model with deep-learning-based objective assessment for voice conversion can be used to assess the speech quality; and an objective indicator, for example, a speech signal-to-noise ratio assessment can be used to assess the speech quality. Further, an overlapped speech detection technology can be used to confirm whether or not the speech data contains only the speech from one person. It should be noted that the above-described methods for assessing the speech quality are not used to limit the scope of the method and the system for automated speaker enrollment, but any other indicators which can be used to assess the speech quality can embody the quality checking unit 403.

Next, the automated speaker enrollment system uses the target speech recording unit 207 to acquire the geometry flag (“0” or “1”) 215 from the target speaker detection unit 205, the enhanced speech 415 from the speech enhancement unit 401, and the quality flag (“0” or “1”) 413 from the quality checking unit 403. In one embodiment of the present disclosure, the target speech recording unit 207 determines whether or not to start to record the enhanced speech 415 according to the above-mentioned information. When the geometry flag 215 is “1” and the quality flag 413 is “1”, the target speech recording unit 207 starts to record the speech, which is enhanced by the speech enhancement unit 401, produced by the target speaker so as to generate the speech data used for enrollment. The speaker enrollment unit 209 converts the speech data into the speaker features for the target speaker. For example, the speaker enrollment unit 209 converts a low-dimensional array into the speaker embedding vector 217.

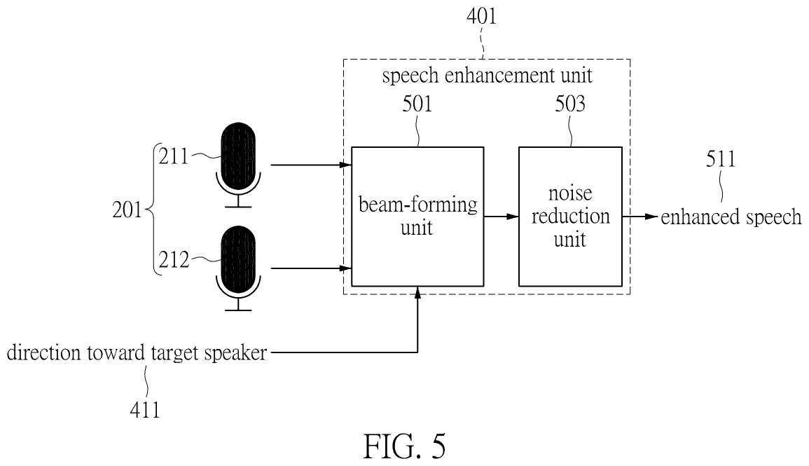

Reference is made to FIG. 5, which is a schematic diagram illustrating the speech enhancement unit 401 according to one embodiment of the present disclosure.

The speech enhancement unit 401 obtains the speech data from the multiple microphones (e.g., the first microphone 211 and the second microphone 212) of the microphone array 201. The speech enhancement unit 401 incorporates a spatial filtering technology to enhance the speech data being received from the target speaker direction 411. The spatial filtering can be implemented through a beam-forming unit 501 that performs beamforming so as to enhance the speech data being obtained from the target speaker direction 411.

Further, the speech data can be enhanced through noise reduction, and therefore the speech enhancement unit 401 reduces noises from the speech data by a noise reduction unit 503. The noise reduction unit 503 can further suppress background noises for enhancing the speech quality based on the characteristics of the speech and the noises. For example, after the noise reduction unit 503 estimates various types of noises, a signal-to-noise ratio transfer function is used to reduce the noises. Still further, a deep-learning method can directly estimate the speech data so as to learn a corresponding mask, and therefore the speech data without noises can be obtained from the original speech data. The enhanced speech 511 is finally outputted. It should be noted that an order of the steps of noise reduction and spatial filtering operated in the speech enhancement unit 401 is not limited by the above embodiments, but is changeable.

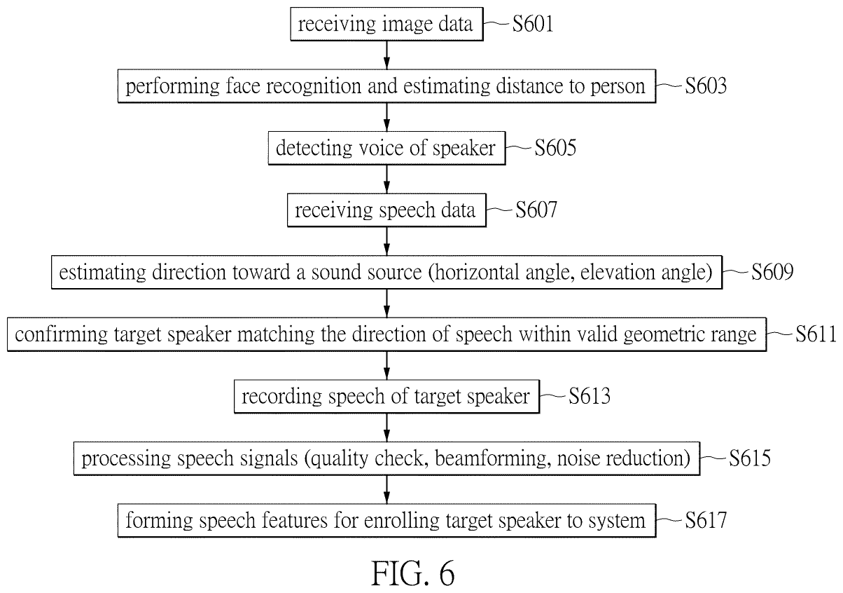

Through the operations of the components depicted in FIG. 2 to FIG. 5 of the automated speaker enrollment system, reference is next made to FIG. 6, which is a flowchart illustrating the method for automated speaker enrollment according to certain embodiments of the present disclosure.

In the beginning of the method for automated speaker enrollment operated in the above-described system, a camera is used to capture images within a valid geometric range, and the image signals are processed to generate image data (step S601). A facial recognition process is performed on the image data for recognizing a facial position of at least one person and estimating a distance from each of the recognized persons (step S603).

Next, multiple microphones of a microphone array are configured to receive audio so as to detect the speech from any of the speakers. The system can rely on a pitch and/or volume of the received speech to detect whether any speaker is speaking (step S605). In the meantime, speech data is generated by the microphone array when receiving audio from any of the speakers (step S607). It should be noted that the order of the interchangeable step S605 and the step S607 presented in the figure is not intended to limit the scope of the invention and can also be performed simultaneously. After any speaker who is speaking is confirmed, in addition to calculating speech features of the speaker, a sound localization process is performed for estimating a sound source direction. The sound source direction is composed of a horizontal angle and an elevation angle (step S609).

Afterwards, a software process is used to determine the person within the valid geometric range according to the facial position of the at least one person. The target speaker can be obtained when the facial position is matched with the sound source direction within the valid geometric range. The target speaker direction is then confirmed (step S611). The speech of the target speaker can be recorded over the target speaker direction and the speech data is generated (step S613). Speech processing such as quality checking, beam forming and/or noise reduction is then performed on the speech data (step S615) so as to generate the speaker features that are used to enroll to a specific system (step S617).

In one of the embodiments of the present disclosure, the method for automated speaker enrollment is operated in an operating system of a computer system or an electronic device. Thus, when the speaker features of the target speaker are formed, the speaker features can be used to automatically enroll to the operating system and allow the target speaker to log in to the operating system by his speech.

In conclusion, according to the certain embodiments of the method for automated speaker enrollment and the automated speaker enrollment system, rather than relying on facial recognition of the speaker and lip motion of the speaker to determine a timing to record the speech of the speaker as in the conventional technology, the automated speaker enrollment system identifies the target speaker through sound localization and facial recognition technology. In the method, the target speaker is identified when the facial position of the speaker is matched with the position being estimated through the microphone array. After that, the speech of the target speaker can be recorded and the speech data is generated. The speech data of the target speaker can be converted into the speaker features used to enroll to a specific system. Therefore, shortcomings of the conventional technology can be improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for automated speaker enrollment, comprising:
using a camera to capture an image so as to generate image data that is used to recognize a facial position of at least one person;
using a microphone array to receive audio so as to generate speech data that is used to estimate a sound source direction through sound localization;
matching a target speaker according to the facial position of the at least one person and the sound source direction;
recording received speech data over a target speaker direction; and
generating speaker features of the target speaker for enrollment in a system.

2. The method according to claim 1, wherein, when the microphone array receives the audio detection is performed to determine whether or not any speaker is speaking according to pitch or volume of the received speech data; and the sound localization is performed based on the speech data when the speaker is determined to be speaking within a valid geometric range.

3. The method according to claim 1, wherein the image captured by the camera is referred to for determining whether or not the at least one person is present, and facial recognition is performed when the at least one person is present within a valid geometric range is confirmed.

4. The method according to claim 3, wherein the facial position of the at least one person includes a distance being estimated based on a focus distance of the camera from a face of the at least one person, and the image captured by the camera is used to determine a direction of the face of the at least one person.

5. The method according to claim 4, wherein the facial position of the at least one person within the valid geometric range and the sound source direction within the valid geometric range are referred to for matching the target speaker and confirming the direction toward target speaker.

6. The method according to claim 3, wherein, in a way of obtaining a face distance of the at least one person, a method of time of flight uses a time difference between a transmitted light and a reflected light to estimate a distance between the at least one person and the camera, a type of a structured light is analyzed for estimating the distance between the at least one person and the camera, or a triangulation method is performed on two images respectively captured by two cameras for calculating the distance between the at least one person and the camera.

7. The method according to claim 1, wherein, after the speech data of the target speaker is recorded, the speech data is processed by quality checking, beamforming or noise reduction.

8. The method according to claim 7, wherein, when the quality checking is performed, a process of assessing speech quality is used to confirm whether or not the speech data includes a single speech by a MOS-Net model with deep-learning-based objective assessment for voice conversion, speech signal-to-noise ratio assessment, or an overlapped speech detection technology.

9. The method according to claim 7, wherein the speech data of the target speaker is converted into a low-dimensional array for forming a speaker embedding vector that is taken as speaker features of the target speaker for enrolling to the system.

10. The method according to claim 1, wherein the method for automated speaker enrollment is operated in an operating system, and speaker features of the target speaker are used for automatically enrolling to the operating system and allow the target speaker to log in to the operating system.

11. An automated speaker enrollment system, comprising:
a camera;
a microphone array including at least two microphones disposed at different positions; and
a computer system that performs a method for automated speaker enrollment, comprising:
using the camera to capture an image so as to generate image data that is used to recognize a facial position of at least one person;
using the microphone array to receive audio so as to generate speech data that is used to estimate a sound source direction through sound localization;
matching a target speaker according to the facial position of the at least one person and the sound source direction;
recording received speech data over a direction toward the target speaker; and
generating speaker features of the target speaker for enrollment in a system.

12. The automated speaker enrollment system according to claim 11, wherein the method for automated speaker enrollment is operated in an operating system, and speaker features of the target speaker are used for automatically enrolling to the operating system and allow the target speaker to logon the operating system.

13. The automated speaker enrollment system according to claim 11, wherein, when the microphone array receives the audio, it is detected whether or not any speaker is speaking according to pitch or volume of the received speech data; and the sound localization is performed based on the speech data when it is confirmed that the speaker is speaking within a valid geometric range.

14. The automated speaker enrollment system according to claim 11, wherein the image captured by the camera is referred to for determining whether or not the at least one person is present; facial recognition is performed when the at least one person being present within a valid geometric range is confirmed.

15. The automated speaker enrollment system according to claim 14, wherein the facial position of the at least one person includes a distance being estimated based on a focus distance of the camera from face of the at least one person and the image captured by the camera is used to determine a direction of the face of the at least one person.

16. The automated speaker enrollment system according to claim 15, wherein the facial position of the at least one person within the valid geometric range and the sound source direction within the valid geometric range are referred to for matching the target speaker and confirming the direction toward target speaker.

17. The automated speaker enrollment system according to claim 16, wherein the method for automated speaker enrollment is operated in an operating system and speaker features of the target speaker are formed for enrolling to the operating system, so that the target speaker logs on the operating system by his speech.

18. The automated speaker enrollment system according to claim 11, wherein, after the speech data of the target speaker is recorded, the speech data is configured to be processed by quality checking, beamforming or noise reduction.

19. The automated speaker enrollment system according to claim 18, wherein the speech data of the target speaker is converted into a low-dimensional array for forming a speaker embedding vector that acts as speaker features of the target speaker for enrolling to the system.

20. The automated speaker enrollment system according to claim 19, wherein the method for automated speaker enrollment is operated in an operating system and speaker features of the target speaker are used for automatically enrolling to the operating system and allow the target speaker to logon the operating system.
